(19) United States
(12) Patent Application Publication
(10) Pub. No.: US 2013/0262601 A1
(43) Pub. Date: Oct. 3, 2013

(54) METHOD AND DEVICE FOR SENDING AND RECEIVING EMAILS

(71) Applicant: INTERNATIONAL BUSINESS MACHINES CORPORATION, Armonk, NY (US)

(72) Inventors: Sheng Hua Bao, Beijing (CN); Jian Chen, Beijing (CN); Zhong Su, Beijing (CN); Xin Ying Yang, Beijing (CN); Xiang Zhou, Beijing (CN)

(73) Assignee: International Business Machines Corporation, Armonk, NY (US)

(21) Appl. No.: 13/826,525

(22) Filed: Mar. 14, 2013

(30) Foreign Application Priority Data
Mar. 31, 2012 (CN) 201210093086.8

(51) Int. Cl. H04L 12/58

(52) U.S. Cl. CPC H04L 51/063
USPC 709/206

(57) ABSTRACT

A method and a device for sending and receiving emails. The present invention provides a method for sending an email that includes determining at least one identical data block between the email to be sent and a historical email. The method further includes determining whether there is a record of the identical data block in a first historical data block index table which includes a matching pair. The matching pair records the correspondence between one historical data block and a hash value. The method further includes, expressing the identical data block in the email to be sent as the corresponding hash value. The method further includes forming a modified email to be sent in response to the presence of the record. The present invention increases the efficiency of sending and receiving emails.

### CROSS-REFERENCE TO RELATED APPLICATION

This application claims priority under 35 U.S.C. §119 from Chinese Patent Application 201210093086.8 filed on Mar. 31, 2012, the entire contents of which are incorporated herein by reference.

### BACKGROUND OF THE INVENTION

1. Field of the Invention

The present invention is related to a technical solution of email delivery, and more particularly, to a method and a device for email delivery which can reduce data transmission amount.

2. Description of the Related Art

Email is a popular form of information transmission and plays a more and more important role in our everyday life and work.

When emails are being sent and received there is a large amount of duplicate information. When a user receives or sends an email containing duplicate data, a waste of bandwidth often happens, and the time for receiving or sending the email is increased. In particular, data transmission in an email between client end and a server largely affects the user's experience. In a real situation where email is used, for example, at the time of forwarding or replying to an email containing a long email thread, a user often receives an email containing a plurality of other emails. In a case where a number of senders participate in a specific email, a user even receives the whole email thread more than once, or the user will receive a plurality of partially duplicate email threads from different senders. Therefore, when such an email is handled in a conventional manner, there is a large amount of duplicate data transmission.

The conventional processing of such a complicated email thread structure leads to a decrease in efficiency of data transmission and a waste of storage space at the email server and at the email client.

Therefore, there is still room for improvement on the prior art. A method and a device is needed to reduce duplicate transmission in handling email.

### SUMMARY OF THE INVENTION

An aspect of the present invention provides a method for sending an email. The method includes determining at least one identical data block between the email to be sent and a historical email. The method further includes determining whether there is a record of the identical data block in a first historical data block index table which includes a matching pair. The matching pair records the correspondence between one historical data block and a hash value. The method further includes, expressing the identical data block in the email to be sent as the corresponding hash value. The method further includes forming a modified email to be sent in response to the presence of the record. At least one of the steps is carried out with a computer.

Another aspect of the present invention provides a method for receiving email. The method includes receiving a modified email to be sent which includes a hash value. The hash value is for expressing an identical data block. The method further includes restoring the hash value in the modified email to be sent to a corresponding data block according to a second historical data block index table. The second historical data block index table includes a matching pair. The matching pair records the correspondence between one historical data block and a hash value. At least one of the steps is carried out with a computer device.

Another aspect of the present invention provides a device for sending email. The device includes a comparison module to determine at least one identical data block between an email to be sent and a historical email. A query module to determine whether there is a record of the identical data block in a first historical data block index table which includes a matching pair. The matching pair records the correspondence between one historical data block and a hash value. A module used to express the identical data block in the email to be sent as the corresponding hash value. A modification module to form a modified email to be sent in response to the presence of the record.

Another aspect of the present invention provides a device for receiving mail. The device includes a receiving module to receive a modified email to be sent, which includes a hash value. The hash value is for expressing an identical data block. A restoring module to restore the hash value in the modified email to be sent to the corresponding data block according to a second historical data block index table. The second historical data block index table includes a matching pair. The matching pair records the correspondence between one historical data block and the hash value.

### BRIEF DESCRIPTION OF THE DRAWINGS

The detailed description of the preferred embodiments with reference to the accompanying drawings will make the objects, features, and advantages of the present invention more apparent. The same reference generally refers to the same components in the exemplary embodiments of the present invention.

FIG. 1 shows a block diagram of an exemplary computer system 100 which is applicable to implement the embodiments of the present invention.

FIG. 2 shows an email sending method applied at a sending end according to an embodiment of the present invention.

FIG. 3 shows an email receiving method applied at a receiving end according to an embodiment of the present invention.

FIG. 4 shows an email sending device applied at a sending end according to a further embodiment of the present invention.

FIG. 5 shows an email receiving device applied at a receiving end according to a further embodiment of the present invention.

FIG. 6 shows how to implement the technical solution of the present application through an index table of data block with multi-granularity according to a further embodiment of the present invention.

### DETAILED DESCRIPTION OF THE PREFERRED EMBODIMENTS

Some preferable embodiments will be described in more detail with reference to the accompanying drawings. The present invention can be implemented in various manners, and should not be construed to be limited to the embodiments disclosed herein. The embodiments are provided for the thorough and complete understanding of the present invention, and conveying the scope of the present invention to those skilled in the art.

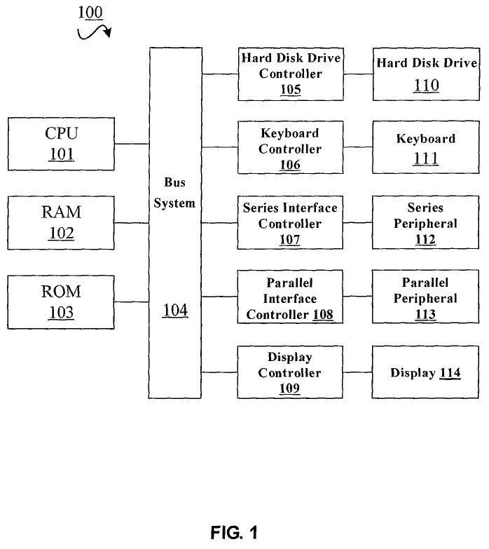

FIG. 1 shows an exemplary computer system 100 which is applicable to implement the embodiments of the present invention. As shown in FIG. 1, the computer system 100 can include: CPU (Central Process Unit) 101, RAM (Random Access Memory) 102, ROM (Read Only Memory) 103, System Bus 104, Hard Drive Controller 105, Keyboard Controller 106, Serial Interface Controller 107, Parallel Interface Controller 108, Display Controller 109, Hard Drive 110, Keyboard 111, Serial Peripheral Equipment 112, Parallel Peripheral Equipment 113 and Display 114. Among above devices, CPU 101, RAM 102, ROM 103, Hard Drive Controller 105, Keyboard Controller 106, Serial Interface Controller 107, Parallel Interface Controller 108 and Display Controller 109 are coupled to the System Bus 104. Hard Drive 110 is coupled to Hard Drive Controller 105. Keyboard 111 is coupled to Keyboard Controller 106. Serial Peripheral Equipment 112 is coupled to Serial Interface Controller 107. Parallel Peripheral Equipment 113 is coupled to Parallel Interface Controller 108. And, Display 114 is coupled to Display Controller 109. It should be understood that the structure as shown in FIG. 1 is only for the exemplary purpose rather than any limitation to the present invention. In some cases, some devices can be added to or removed from the computer system 100 based on specific situations.

As will be appreciated by one skilled in the art, aspects of the present invention can be embodied as a system, method or computer program product. Accordingly, aspects of the present invention can take the form of an entirely hardware embodiment, an entirely software embodiment (including firmware, resident software, micro-code, etc.) or an embodiment combining software and hardware aspects that may all generally be referred to as a “circuit,” “module” or “system.” Furthermore, aspects of the present invention can take the form of a computer program product embodied in one or more computer readable medium(s) having computer readable program code embodied thereon.

Any combination of one or more computer readable medium(s) can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain, or store a program for use by or in connection with an instruction execution system, apparatus, or device.

A computer readable signal medium can include a propagated data signal with computer readable program code embodied, for example, in baseband or as part of a carrier wave. Such a propagated signal can take any of a variety of forms, including, but not limited to, electro-magnetic, optical, or any suitable combination. A computer readable signal medium can be any computer readable medium that is not a computer readable storage medium and that can communicate, propagate, or transport a program for use by or in connection with an instruction execution system, apparatus, or device.

Program code embodied on a computer readable medium can be transmitted using any appropriate medium, including but not limited to wireless, wireline, optical fiber cable, RF, etc., or any suitable combination of the foregoing.

Computer program code for carrying out operations for aspects of the present invention can be written in any combination of one or more programming languages, including an object oriented programming language such as Java, Smalltalk, C++ or the like and conventional procedural programming languages, such as the “C” programming language or similar programming languages. The program code can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions can also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions can also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

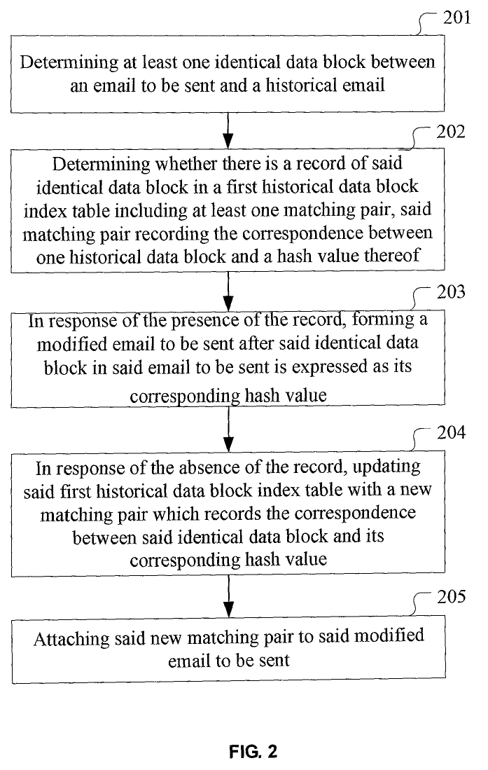

FIG. 2 shows an email sending method applied at a sending end for sending an email to a receiving end. In step 201, at least one identical data block is determined between an email to be sent and a historical email. In one embodiment, the sending end is the email client end, and the email to be sent is a newly created email which is created at the user client and which is ready to be sent to the email server end as the receiving end. In another embodiment, the email to be sent is a new email which is received at the email server end as the sending end and which is ready to be sent to the email client as the receiving end.

According to one embodiment, the email to be sent is compared with a relevant historical email to determine the above-mentioned identical data block. The relevant historical email is an email which possibly has a data block identical to the email to be sent. Upon determination of the relevant email, those skilled in the art can readily conceive various implementations. For example, the determination can be made according to the correlation of senders and recipients of emails, or can be made according to the correlation of content of emails. Those implementations are not to be enumerated one by one. In one embodiment, the relevant email can be an email similar to the email to be sent. For example, according to whether the email to be sent is a reply email or a forward email, the operated source email can be determined as the similar email. Determination on an identical data block can be made in the following several specific ways: the email to be sent is compared with the relevant historical email as a whole, and if they are identical with each other, it is considered that the email to be sent and the relevant historical email are identical data block as a whole. Also, according to the data structure of an email, the email can be divided into data blocks of an email header, an email body and an email attachment, etc. Then these corresponding data blocks in the email to be sent and in the relevant email are compared to determine whether they are identical respectively. Also, a certain specific data block (e.g., the email body, the email attachment) can be further divided into data blocks of finer granularity. In one specific embodiment of the present invention, a character string comparison method can be adopted to find different portions and identical portions of the two data blocks to be compared.

In step 202, it is determined whether there is a record of the identical data block in a first historical data block index table having at least one matching pair. The matching pair records the correspondence between one historical data block and a hash value. The historical data block index table is a record table which is used to maintain the correspondences between historical data blocks and hash values. The correspondence recorded in each matching pair can be data block descriptive information (or the data block itself or a reference to the data block) as well as the hash value corresponding to the data block. The historical data block corresponding to each hash value in the index table is available data stored at the sending end or the receiving end.

A hash value is a numeric value obtained through logical operations according to content of a data block. The hash value can be regarded as the fingerprint of each data block. If the data block is different, the hash value is different. MD5 and SHA1 are widespread HASH algorithms. Those skilled in the art can understand how to obtain a hash value of a data block by applying the hash algorithm, which is not described here for simplification.

The historical data block can be of multi-granularity. Calculation of the hash value can be performed on the whole email, or data blocks of different granularity can be obtained by dividing according to the structure of the email, so that an index table of data blocks with multi-granularity is maintained. According to a specific need, for example, the size of a file block of the smallest granularity can be set to 100 K. In one embodiment, an email can be divided according to the same rule at the server end and at the client end to ensure the synchronization relationship between them.

In step 203, in response to the presence of a record, a modified email to be sent is formed after the identical data block in the email to be sent is expressed as its corresponding hash value. Through the modification, the portion of the identical data block is sent to the receiving end in the form of a hash value, and the portions of different data blocks are directly sent to the receiving end. Those skilled in the art can employ an appropriate method to distinguish the hash value from the other portions of the email in the modified, newly created email. For example, a method in which the identifiers are used can be employed, which is not described here for simplification.

Steps 204 and 205 are optional steps. In step 204, in response to the absence of a record, the first historical data block index table is updated with a new matching pair which records the correspondence between the identical data block and its corresponding hash value.

In step 205, the new matching pair is attached to the modified email to be sent. A historical data block is a data block in a historical email. In one embodiment, the historical data block is synchronously stored at the sending end and at the receiving end. It is necessary to synchronize the first historical data block index table and the second historical data block index table. The new matching pair is used to synchronously update the second historical data block index table located at the receiving end.

In one embodiment, the step 201 for determining the identical data block in FIG. 2 includes the following sub-steps. In sub-step 1a relevant email of the email to be sent is searched for in historically received and sent emails. In sub-step 2, the identical data block is determined depending on whether corresponding portions of the email to be sent and its relevant email are identical. The corresponding portions can be the email as a whole, or can be a plurality of data block areas divided according to the data structure of the email, such as the email header, the email body and the email attachment, etc.

With the use of the technical solution described in FIG. 2, an email can be divided into data blocks with multi-granularity. Efficient email delivery is achieved through a hash index table of data blocks with multi-granularity.

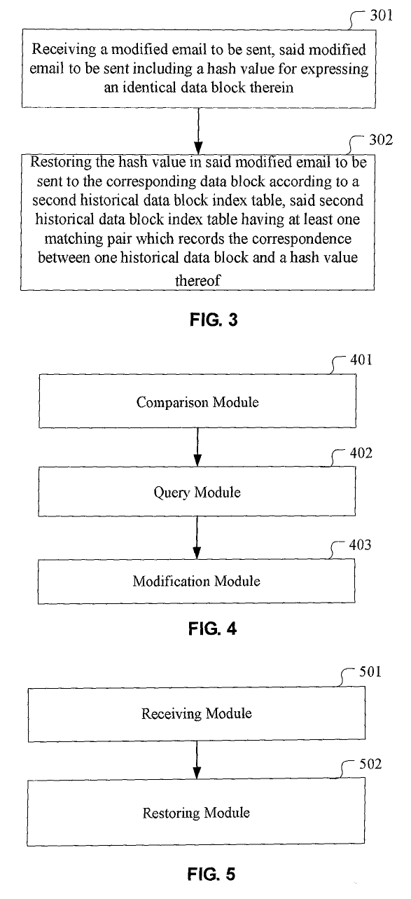

FIG. 3 shows an email receiving method applied at the receiving end for receiving an email from the sending end. In step 301, a modified email to be sent is received. The modified email to be sent includes a hash value for expressing an identical data block. In one embodiment, the modified email to be sent is a modified email to be sent which is received at the server end and from the client. In another embodiment, the modified email to be sent is a modified email to be sent which is received at the client and from the server end.

In step 302, the hash value in the modified email to be sent is restored to its corresponding data block according to the second historical data block index table. The second historical data block index table has at least one matching pair which records the correspondence between one historical data block and a hash value.

In one embodiment, the sending end is the email client or the email delivery server, and the receiving end is the email delivery server or the email client. In another embodiment, the second historical data block index table is synchronously updated with the first historical data block index table located at the sending end.

FIG. 4 shows an email sending device applied at the sending end for sending an email to the receiving end. A comparison module 401 is configured to determine at least one identical data block between an email to be sent and a historical email.

A query module 402 is configured to determine whether there is a record of the identical data block in a first historical data block index table having at least one matching pair, the matching pair recording the correspondence between one historical data block and a hash value.

A modification module 403 configured to, in response to the presence of a record, form a modified email to be sent after the identical data block in the email to be sent is expressed as its corresponding hash value.

In one improved embodiment, on the basis of the device shown in FIG. 4, a module configured to, in response to the absence of a record, update the first historical data block index table with a new matching pair which records the correspondence between the identical data block and its corresponding hash value, and a module configured to attach the new matching pair to the modified email to be sent can further be included. The new matching pair is used to update the second historical data block index table located at the receiving end.

In another improved embodiment, the comparison module 401 includes: a module configured to search for a relevant email of the email to be sent in the historical emails. A module configured to determine the identical data block depending on whether corresponding portions of the email to be sent and the relevant email are identical, where the corresponding portions are the emails as a whole, or data block portions divided according to the data structure of the email.

In one embodiment, the sending end is the email client or the email delivery server, and the receiving end is the email delivery server or the email client.

FIG. 5 shows an email receiving device applied at the receiving end for receiving an email from the sending end. A receiving module 501 configured to receive a modified email to be sent, the modified email to be sent including a hash value for expressing an identical data block.

A restoring module 502 configured to restore the hash value in the modified email to be sent to a corresponding data block according to the second historical data block index table, the second historical data block index table having at least one matching pair which records the correspondence between one historical data block and a hash value. In one improved embodiment, the second historical data block index table is synchronously updated with the first historical data block index table located at the sending end. In another specific embodiment, the sending end is the email client or the email delivery server, and the receiving end is the email delivery server or the email client.

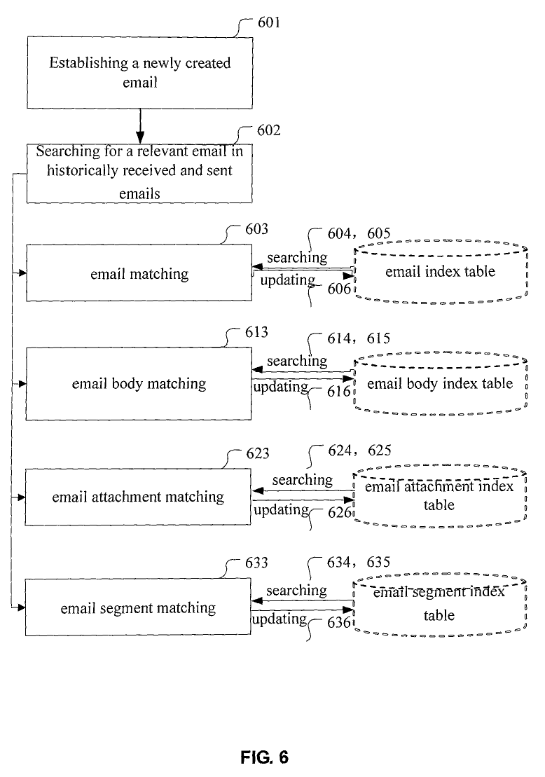

FIG. 6 shows how to implement the technical solution of the present application through an index table of data block with multi-granularity in a more specific embodiment. In this embodiment, the data block's granularity levels include email, email body, email attachment and email segment, etc. Accordingly, the historical data block index table includes email index table, email body index table, email attachment index table and email segment index table, etc., according to different granularity of the data block.

In step 601, a newly created email is established at the client and it is ready to be sent to the email server end. In step 602, a relevant email of the newly created email is searched for historically received and sent emails. Next, the process can advance to step 603, step 613, step 623 and step 633 respectively or in order. In step 603, on the basis of the relevant email, it is judged whether the email is an identical data block as the whole email. In step 604, if it is identical, it is searched whether there is a record of a corresponding email-email hash value matching pair in the email index table, where the email index table includes a plurality of email-email hash value matching pairs, each matching pair records the correspondence between one historical email and a hash value.

In step 605, if there is such a record, the email hash value (mailhashid) is used to express the duplicate email and is sent to the server end (the server end restores content of the complete email through the hash value).

In step 606, if there is not such a record, a new email-email hash value matching pair is created and the email index table is updated, and when the email is sent, the email hash value and its corresponding email mark information are transmitted (after the server receives the new email-email hash value matching pair, it will also update the email index table at the server end).

In step 613, the body of the newly created email is matched with that of the relevant email. In step 614, if the email bodies are completely matched, it is searched whether there is a record of a corresponding email body-body hash value matching pair in the email body index table, where the email body index table includes a plurality of body-body hash value (bodyhashid) matching pairs, each matching pair is the correspondence between one historical email body and a hash value.

In step 615, if there is such a record, the body hash value is used to express the corresponding body in the newly created email to form a modified newly created email to be sent to the email server end (the server end restores the complete body content through the hash value).

In step 616, if there is not such a record, a new body-body hash value matching pair is created to update the body index table, and when the email is sent, the body hash value and its corresponding body mark information are transmitted together. After the server receives the new body-body hash value matching pair, it will also update the body index table at the server end.

In step 623, the attachment of the newly created email is matched with that of the relevant email. In step 624, if the emails' attachments are completely matched, it is searched whether there is a corresponding attachment-attachment hash value matching pair in the attachment index table, where the attachment index table includes a plurality of attachment-attachment hash value matching pairs, each matching pair is the correspondence between one historical attachment and a hash value.

In step 625, if there is such a matching pair, the attachment hash value is used to express the corresponding attachment in the newly created email to form a modified newly created email to be sent to the email server end. The server end obtains the content of the complete email by restoring the hash value to a corresponding attachment.

In step 626, if there is not such a matching pair, a new attachment-attachment hash value matching pair is created to update the attachment index table, and when the email is sent, the attachment hash value and its corresponding attachment mark information are transmitted together. After the server receives the new attachment-attachment hash value matching pair, it will also update the attachment index table at the server end.

In step 633, it is determined whether the segments in the email bodies or attachments are matched. In step 634, for each matched segments, it is searched whether there is a corresponding segment-segment hash value matching pair in the segment index table, where the segment index table includes a plurality of segment-segment hash value matching pairs, each matching pair is the correspondence between one historical segment and a hash value.

In step 635, if there is such a matching pair, the segment hash value is used to express the corresponding segment in the newly created email to form a modified newly created email to be sent to the email server end. The server end obtains the content of the complete email by restoring the segment corresponding to the segment hash value.

In step 636, if there is not such a matching pair, a new segment-segment hash value matching pair is created to update the segment index table, and when the email is sent, the segment and its corresponding segment mark information are transmitted together. After the server receives the new segment-segment hash value matching pair, it will also update the segment index table at the server end.

The above-mentioned index tables of data blocks with different granularity can be used separately or in combination. When they are used in combination, it is possible to obtain better technical effects. After the positions of the server and the client are swapped, the above steps are applicable to a situation where the server receives a new email and needs to send the email to the client.

The flowchart and block diagrams in the Figures illustrate the architecture, functionality, and operation of possible implementations of systems, methods and computer program products according to various embodiments of the present invention. In this regard, each block in the flowchart or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed.

What is claimed is:

1. A method for sending an email comprising:
determining at least one identical data block between an email to be sent and a historical email;
determining whether there is a record of said identical data block in a first historical data block index table which includes a matching pair, wherein said matching pair records the correspondence between one historical data block and a hash value;
expressing said identical data block in said email to be sent as the corresponding hash value; and
forming a modified email to be sent in response to the presence of the record;
wherein at least one of the steps is carried out with a computer device.

2. The method according to claim 1, further comprising:
updating said first historical data block index table with a new matching pair which records the correspondence between said identical data block and its corresponding hash value, in response to the absence of the record; and
attaching said new matching pair to said modified email to be sent.

3. The method according to claim 1, wherein said determining of the identical data block comprises:
searching for a relevant email of said email to be sent in said historical emails; and
determining said identical data block based on whether corresponding portions of said email to be sent and said relevant email are identical.

4. The method according to claim 3, wherein corresponding portions can be emails as a whole or data block areas divided according to the data structure of the email.

5. The method according to claim 1, wherein a sending end is an email client or an email delivery server.

6. The method according to claim 1, wherein a receiving end is an email delivery server or an email client.

7. The method according to claim 2, wherein said new matching pair is used to update a second historical data block index table located at a receiving end.

8. A method for receiving an email, comprising:
receiving a modified email to be sent which includes a hash value, wherein the hash value is for expressing an identical data block; and
restoring the hash value in said modified email to be sent to a corresponding data block according to a second historical data block index table, wherein said second historical data block index table includes a matching pair;
wherein the matching pair records the correspondence between one historical data block and a hash value; and
wherein at least one of the steps is carried out with a computer device.

9. The method according to claim 8, wherein said second historical data block index table is synchronously updated with a first historical data block index table located at a sending end.

10. The method according to claim 8, wherein a sending end is an email client or an email delivery server and a receiving end is an email delivery server or an email client.

11. A device for sending an email, comprising:
a memory;
a processor communicatively coupled to the memory;
a comparison module configured to determine at least one identical data block between an email to be sent and a historical email;
a query module configured to determine whether there is a record of said identical data block in a first historical data block index table which includes a matching pair, wherein said matching pair records the correspondence between one historical data block and a hash value;
a module to express the identical data block in said email to be sent as the corresponding hash value; and
a modification module configured to form a modified email to be sent in response to the presence of the record.

12. The device according to claim 11, further comprising:
a module to update said first historical data block index table with a new matching pair which records the correspondence between said identical data block and its corresponding hash value, in response to the absence of the record; and
a module to attach said new matching pair to said modified email to be sent.

13. The device according to claim 11, wherein said comparison module comprises:
a module to search for a relevant email of said email to be sent in said historical emails; and
a module to determine said identical data block, depending on whether corresponding portions of said email to be sent and said relevant email are identical.

14. The device according to claim 13, wherein said corresponding portions can be emails as a whole or data block areas divided according to the data structure of the email.

15. The device according to claim 11, wherein a sending end is an email client or an email delivery server.

16. The device according to claim 11, wherein a receiving end is an email delivery server or an email client.

17. The device according to claim 12, wherein said new matching pair is used to update a second historical data block index table located at a receiving end.

18. A device for receiving email comprising:
a memory;
a processor communicatively coupled to the memory;
a receiving module to receive a modified email to be sent which includes a hash value, wherein the hash value is for expressing an identical data block; and
a restoring module to restore the hash value in said modified email to be sent to the corresponding data block according to a second historical data block index table;
wherein said second historical data block index table includes a matching pair; and
wherein the matching pair records the correspondence between one historical data block and a hash value.

19. The device according to claim 18, wherein said second historical data block index table is synchronously updated with a first historical data block index table located at a sending end.

20. The device according to claim 18, wherein a sending end is an email client or an email delivery server and a receiving end is an email delivery server or an email client.
